(19) United States
(12) Patent Application Publication
(10) Pub. No.: US 2008/0216617 A1
(43) Pub. Date: Sep. 11, 2008

(54) Tool for removing a tire stem cap

(76) Inventor: Guy C. Goodine, Pahrump, NV (US)

Correspondence Address: LITMAN LAW OFFICES, LTD., P.O. BOX 15035, CRYSTAL CITY STATION, ARLINGTON, VA, 22215, US

(21) Appl. No.: 12/071,103

(22) Filed: Feb. 15, 2008

Related U.S. Application Data
(60) Provisional application No. 60/905,329, filed on Mar. 7, 2007.

(51) Int. Cl. B25B 23/08

(52) U.S. Cl. 81/451

(57) ABSTRACT

The tool for removing a tire valve stem cap is an elongated tool that allows a user to easily reach the valve stem of dual tires. The tool includes an elongated handle portion having opposed front and rear ends, and a head portion joined to the front end of the handle portion. The head portion has a recess centrally formed in a front face thereof and a resilient annular gripping member disposed in the recess. The annular gripping member has a central bore formed therethrough, with the central bore being dimensioned and configured for frictionally engaging the tire valve stem cap for removal and insertion thereof.

### CROSS-REFERENCE TO RELATED APPLICATION

This application claims the benefit of U.S. Provisional Patent Application Ser. No. 60/905,329, filed Mar. 7, 2007.

### BACKGROUND OF THE INVENTION

1. Field of the Invention

The present invention relates to accessories for vehicle tires, and particularly to a tool for removing a tire valve stem cap that aids in the removal and replacement of tire valve stem caps from dual-tire wheel assemblies.

2. Description of the Related Art

Dual-tire wheels are commonly found on trucks and other heavy vehicles. The tire air valves are typically found on the innermost tire (as shown in FIG. 1), which makes removal or replacement of the valve cap extremely difficult for most users. Attempting to reach the valve cap through the outer tire rim can result in staining of the user's clothing from accumulated dirt, tar, etc., or may even result in injury to the user through abrasions with the metal rim. Thus, a tool for removing a tire valve stem cap solving the aforementioned problems is desired.

### SUMMARY OF THE INVENTION

The tool for removing a tire valve stem cap is an elongated tool, allowing a user to easily reach the valve stem on dual tires. The tool includes an elongated handle portion having opposed front and rear ends, and a head portion joined to the front end of the handle portion.

Preferably, the elongated handle portion has a substantially cylindrical contour and the head portion has a substantially circular cross-sectional contour. In some embodiments, the head portion has a larger diameter than the elongated handle portion, the head portion having a flared or substantially bell-shaped contour.

The head portion has a recess centrally formed in a front face thereof for receiving an annular gripping member. The annular gripping member has a central bore formed therethrough, with the central bore being dimensioned and configured for frictionally engaging the tire valve stem cap for removal and insertion thereof. The annular gripping member may be formed from rubber, plastic or the like, allowing for frictional engagement with the tire valve stem cap.

These and other features of the present invention will become readily apparent upon further review of the following specification and drawings.

### BRIEF DESCRIPTION OF THE DRAWINGS

FIG. 1 is an environmental, perspective view of a tool for removing a tire valve stem cap according to the present invention.

FIG. 2 is a side view of the tool for removing a tire valve stem cap according to the present invention.

FIG. 3 is a partial perspective view of the tool for removing a tire valve stem cap according to the present invention, broken away and partially in section to show details thereof.

FIG. 4 is an end view of the tool for removing a tire valve stem cap according to the present invention.

FIG. 5 is a partial perspective view of an alternative embodiment of the tool for removing a tire valve stem cap according to the present invention, broken away and partially in section to show details thereof.

FIG. 6 is a side view of the embodiment of FIG. 5, partially broken away and in section, showing how a valve stem cap fits into the head of the tool.

Similar reference characters denote corresponding features consistently throughout the attached drawings.

### DETAILED DESCRIPTION OF THE PREFERRED EMBODIMENT

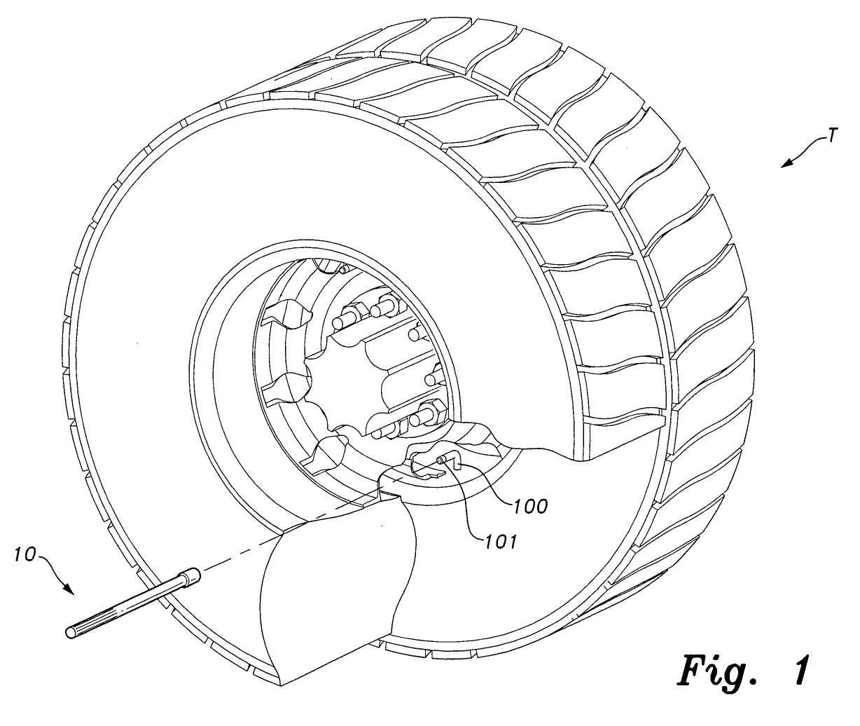

The present invention is directed towards a tool for removing a tire valve stem cap. As best shown in FIG. 1, the tool 10 is an elongated tool, allowing a user to easily reach a valve stem cap 101 of a tire valve stem 100. Tool 10 is particularly useful in removing and replacing a valve stem cap 101 on dual tires, such as exemplary tire assembly T, although it should be understood that tool 10 may be used in combination with any suitable tire or wheel assembly.

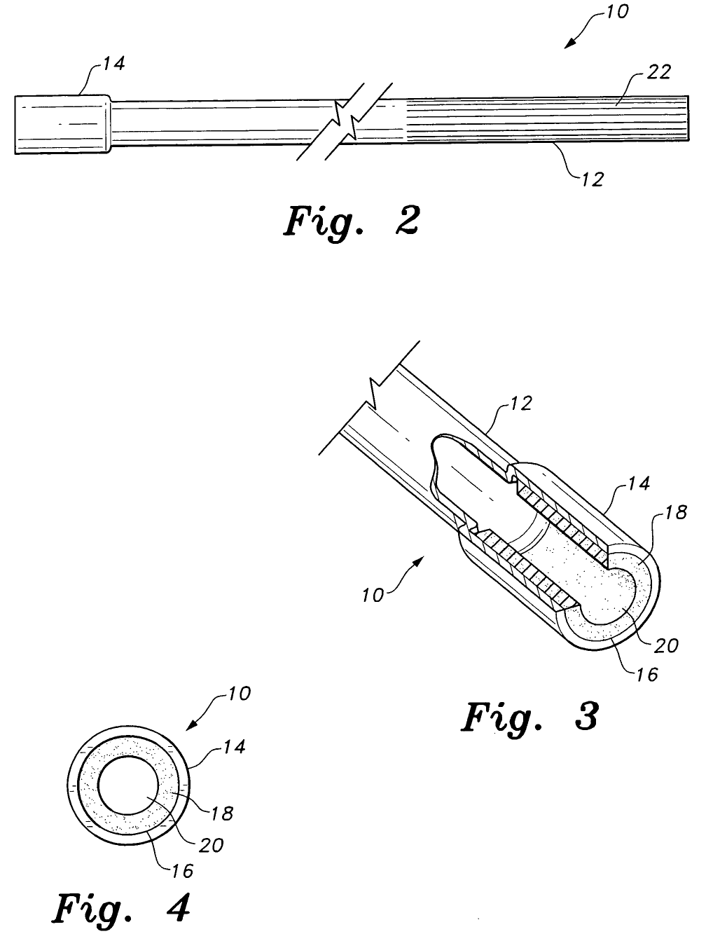

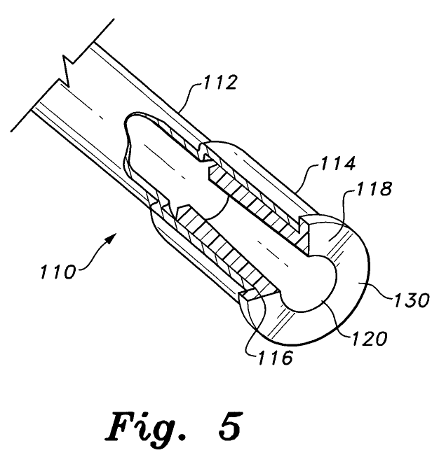

As shown in FIG. 2, tool 10 includes an elongated handle portion 12 having opposed front and rear ends, and a head portion 14 joined to the front end of the handle portion 12. Preferably, the elongated handle portion 12 has a substantially cylindrical contour, and the head portion 14 is substantially circular in cross section (best shown in FIG. 4). In the preferred embodiment, the head portion 14 has a larger diameter than the elongated handle portion 12, with the head portion 14 having a flared or substantially bell-shaped contour.

In the some embodiments, elongated handle portion 12 and head portion 14 are formed from aluminum, although it should be understood that tool 10 may be formed from any suitable, structurally strong material. Further, in the some embodiments, tool 10 is approximately eighteen inches long, elongated handle portion 12 is approximately ⅝ of an inch in diameter, and head portion 14 has an outer diameter of approximately three-quarters of an inch.

The head portion 14 has a recess or opening 16 centrally formed in a front face thereof for receiving an annular gripping member 18 therein. The annular gripping member 18 has a central bore 20 formed therethrough, with the central bore 20 being dimensioned and configured for frictionally engaging and releasably retaining the tire valve stem cap 101 for selective removal and insertion thereof. The annular gripping member 18 may be formed from rubber, plastic or other resilient material, allowing for releasable frictional engagement with the tire valve stem cap 101.

In FIGS. 3 and 4, the annular gripping member 18 is shown as having a substantially annular cross-sectional contour, with both the inner and outer perimeters being circular in appearance. It should be understood that the inner surface of annular gripping member 18 may be contoured to increase frictional engagement with tire valve stem cap 101 through the addition of knurling or the like. Annular gripping member 18 may be secured within head portion 14 through the use of glue or any other suitable adhesive or other fastening means.

As shown in FIGS. 1 and 2, the outer surface of handle portion 12 may include knurling 22 or other surface configuration or additional gripping elements in order to increase the frictional coefficient thereof. Knurling 22 allows the user to retain a stable grip on handle portion 12. Further, although shown as having a static head 14 fixed to static handle portion 12, it should be understood that head 14 may be a ratcheting head, or a similar tool having a rotating head, or portion of the head, with respect to the handle.

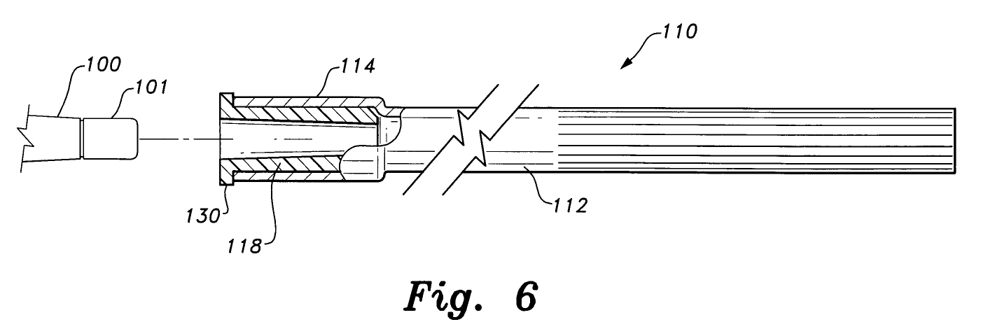

In the alternative embodiment of FIGS. 5 and 6, tool 110 includes an elongated handle 112 and a head portion 114, mounted thereon, similar to that described above with reference to FIGS. 1-4. Head portion 114 has a recess or opening 116 centrally formed in a front face thereof for receiving a gripping member 118 therein. Annular gripping member 18 of FIGS. 1-4 had a substantially cylindrical bore, but the gripping member 118 has a central bore 120 formed therethrough that tapers, with a decreasing diameter along the direction from the open end of head 114 towards the handle 112 (for engaging the rounded valve stem cap 101 of valve stem 100). The central bore 120 is dimensioned and configured for frictionally engaging and releasably retaining the tire valve stem cap 101 for selective removal and insertion thereof. Similar to annular gripping member 18, gripping member 118 may be formed from rubber, plastic or other resilient, allowing for releasable frictional engagement with the tire valve stem cap 101. Preferably, a rim or annular lip 130 is formed about the open end of gripping member 118, as shown, for secure grasping by the user or a tool holder, during use, transport or storage and to ensure proper seating of the gripping member in head 114.

It is to be understood that the present invention is not limited to the embodiment described above, but encompasses any and all embodiments within the scope of the following claims.

I claim:

1. A tool for removing a tire valve stem cap, comprising:
an elongated handle having opposed front and rear ends;
a head joined to the front end of the handle, the head having a recess centrally formed in a front face thereof; and
an elongated annular gripping member disposed within the recess and attached to the head portion, the annular gripping member having a central bore formed therethrough, the central bore being dimensioned and configured for frictionally engaging the tire valve stem cap.

2. The tool for removing a tire valve stem cap as recited in claim 1, wherein said annular gripping member is formed from rubber.

3. The tool for removing a tire valve stem cap as recited in claim 1, wherein said elongated handle is substantially cylindrical.

4. The tool for removing a tire valve stem cap as recited in claim 3, wherein said head portion is substantially circular in cross section.

5. The tool for removing a tire valve stem cap as recited in claim 1, wherein said gripping member has an annular lip formed at one end thereof for properly seating the gripping member in the recess formed in the head.

6. A tool for removing a tire valve stem cap, comprising:
a longitudinally elongated handle having opposed front and rear ends;
a head joined to the front end of the longitudinally elongated handle, the head having a recess centrally formed in a front face thereof; and
an elongated gripping member disposed within the recess and attached to the head portion, the gripping member having a central bore formed therethrough, the central bore being dimensioned and configured for frictionally engaging the tire valve stem cap.

7. The tool for removing a tire valve stem cap as recited in claim 6, wherein said gripping member is formed from rubber.

8. The tool for removing a tire valve stem cap as recited in claim 6, wherein said longitudinally elongated handle is substantially cylindrical.

9. The tool for removing a tire valve stem cap as recited in claim 8, wherein said head portion is substantially circular in cross section.

10. The tool for removing a tire valve stem cap as recited in claim 6, further comprising a peripheral lip formed about one end of said gripping member.

11. The tool for removing a tire valve stem cap as recited in claim 6, wherein said gripping member is elongated in the longitudinal direction, said gripping member defining an inner radius and an outer radius.

12. The tool for removing a tire valve stem cap as recited in claim 11, wherein the outer radius of said gripping member is constant.

13. The tool for removing a tire valve stem cap as recited in claim 12, wherein the inner radius of said gripping member is constant.

14. The tool for removing a tire valve stem cap as recited in claim 12, wherein the bore defined by said gripping member is tapered, the inner radius of said gripping member decreasing in the longitudinal direction from the front face of the head to the longitudinally elongated handle when said gripping member is inserted in the head.
